(19) United States
(12) Patent Application Publication
(10) Pub. No.: US 2006/0080097 A1
(43) Pub. Date: Apr. 13, 2006

(54) Voice acknowledgement independent of a speaker while dialling by name

(75) Inventor: Gerhard Hoffmann, Eichenau (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, 80333 Munich (DE)

(21) Appl. No.: 10/549,679

(22) PCT Filed: Feb. 16, 2004
(86) PCT No.: PCT/EP04/01437

§ 371 Date: Sep. 19, 2005

(30) Foreign Application Priority Data
Mar. 17, 2003 (DE) 103 11 698.2

(51) Int. Cl. G10L 15/26

(52) U.S. Cl. 704/235

(57) ABSTRACT

An initial voice input is associated with a recognition input in the framework of voice recognition and the recording of the voice input is stored in a memory in association with the recognition input in such a way that the voice input is emitted in the form of an audio response during further acknowledgement processes.

### CROSS REFERENCE TO RELATED APPLICATIONS

This application is based on and hereby claims priority to German Application No. 10311698.2 filed on Mar. 17, 2003, the contents of which are hereby incorporated by reference.

### BACKGROUND OF THE INVENTION

The technology of speech recognition for mobile terminals is now so far advanced that it is possible to implement dialing by name independent of the speaker (Speaker Independent Name Dialing). In this respect, entries in the address book can be dialed directly by speaking the entered name, without training of the voice pattern having to be carried out with the user in advance.

The handsfree mode is restricted in such a form of speech recognition, however, since the user is reliant on the acknowledgment on the display for verification of the recognition result and receives no acoustic acknowledgment of the recognized entry.

To implement an acoustic acknowledgment for speaker-independent name dialing, it is currently assumed that text-to-speech (TTS) components have to be used. These TTS components generate a synthetic voice output from a text. The recognized name entry in an address book can be output in synthesized form. However, the TTS components which have to be used need a level of computing performance which is high for mobile terminals and embedded hardware and also have a large memory requirement, and can therefore only be implemented in a very cost-intensive manner. Furthermore, the voice quality of such TTS systems for mobile devices is of a low level due to the small footprint. Moreover, foreign names are often pronounced in unfamiliar and incorrect ways by TTS systems.

### SUMMARY OF THE INVENTION

An object underlying the invention is that of implementing a voice acknowledgment for a recognized voice input using the least possible resources.

Accordingly, in a method for speech recognition, especially on embedded hardware and/or a mobile terminal, a first voice signal is input by a user by speaking it in. The designation “first” voice signal merely serves the purpose of differentiating the voice signal of this text from further, subsequent voice signals. The inputted first voice signal is recognized, by assigning it to a recognition entry, and recorded, by storing data in memory for the acoustic restoration of the voice signal which is needed for the acoustic representation of the voice signal. Finally, the recording of the inputted first voice signal is stored in memory as being assigned to the recognition entry. This means that it is available for later recognitions as a confirmation signal in the form of a voice acknowledgment.

The recording of the inputted first voice signal is preferably only stored in memory as being assigned to the recognition entry if it is confirmed by the user that the inputted first voice signal has been recognized correctly. Alternatively, or additionally, the storage in memory of a voice signal which has been erroneously assigned to a recognition entry can also be deleted again later.

Prior, especially, to the confirmation that the inputted voice signal has been recognized correctly, a visual representation of the recognition entry can be output on a display. This means that the user can read the visual representation of the recognition entry and then confirm that the voice signal has been recognized correctly.

Following the storage in memory and recognition of the original voice signal, speech recognition operations for further voice signals which are identical or similar to the first voice signal are structured as follows: a further voice signal is input by the user. The further inputted voice signal is recognized by assigning it to the recognition entry. Finally, the recording of the inputted first voice signal stored in memory as being assigned to the recognition entry is output acoustically for the purposes of confirming that the further inputted voice signal has been recognized as the recognition entry.

Additionally to the automatic assignment and storage in memory of voice signals described above, the user can be given the opportunity to record voice signals and assign them manually to recognition entries explicitly himself. To this effect, a desired voice signal is capable of being input and stored in memory in association with a further recognition entry without intervening speech recognition.

The method especially constitutes a method for speaker-independent name dialing. However, it can also be applied to all other application areas of speech recognition, especially speaker-independent speech recognition, where a voice acknowledgment is needed for the purposes of implementing a “Full Handsfree” mode, such as in Command & Control; in Voice Links, especially in Internet navigation; in voice-based selection of applications (Speech Application Selection) and/or in voice-based input of city and street names (City Name Input), for example.

A device which is set up and displays resources to execute the outlined method can be implemented by appropriate programming and setting up of a data processing system, for example. In this respect, the device especially displays resources for inputting the voice signal, resources for recognizing the voice signal by assignment to a recognition entry, and memory resources in which the inputted voice signal is capable of being stored in association with the recognition entry. Advantageous embodiments of the device result in a similar manner to the advantageous embodiments of the method.

The device especially constitutes a mobile terminal, and preferably a mobile communication facility, possibly in the form of a mobile telephone and/or PDA or a mobile navigation facility in the form of a navigation system in a vehicle.

A program product for a data processing system which contains blocks of code with which one of the outlined methods can be executed on the data processing system can be executed by suitable implementation of the method in a programming language and translation into code which can be executed by the data processing system. The blocks of code are stored in memory to this effect. In this respect, ‘a program product’ indicates that the program is a commercial product. It may exist in any desired form; for example, on paper, a computer-readable data medium or distributed across a network.

Further advantages and features of the invention arise from the description of an exemplary embodiment.

The invention makes it possible to implement a voice acknowledgment inexpensively in a step-by-step process without the use of TTS components in the case of speaker-independent name dialing.

### DETAILED DESCRIPTION OF THE PREFERRED EMBODIMENT

According to the invention, a name spoken by a user is, in the case of a voice dialing operation, not only fed to the speech recognition unit, but is additionally also sampled as a stored speech segment in parallel. In the case of the first name dialing operation for an address book entry, the name entry recognized by the speech recognition unit is displayed to the user visually on the screen. Furthermore, the user is requested acoustically, with the aid of a tone, to confirm the recognition result. If the user confirms the result, the recognized address book entry is dialed and the recording of the inputted voice signal, in the form of the recorded stored speech segment, is assigned to the recognition entry, in the form of the address book entry. In the case of every further name dialing operation for that entry, the assigned stored speech segment can then also be used as a voice acknowledgment alongside the visual acknowledgment. This means that the user is informed of the recognition result both visually and also acoustically. This allows a Full Handsfree mode to be achieved which possesses correct, high-quality voice reproduction. The reliably assigned stored speech segment of the user makes it possible in this respect to dispense with the cost-intensive TTS component.

The invention is therefore founded on a self-initiating system which is based on the combination of the voice sampling in the course of speech recognition and the reliable assignment of a voice sample by confirmation of the recognition result.

This should be explained again with reference to a more concrete exemplary embodiment. In a mobile phone, functions of speaker-independent name dialing are implemented by using a speaker-independent, HMM-based speech recognition unit. All the names in the user's address book are made known to the speech recognition unit by way of a grapheme-to-phoneme technology and can therefore be dialed direct by voice.

In the initial state of the system, there are no stored speech segments in association with the address book entries. Upon activation of the functionality for speaker-independent name dialing, the name spoken by the user is fed to the speech recognition unit and sampled as a stored speech segment in parallel. The speech recognition unit returns the recognition result and a check is carried out as to whether a stored speech segment is already present in association with the recognition result.

If there is no stored speech segment as yet, the recognition result is displayed on the screen and the user is requested, with the aid of a voice prompt such as “Confirm recognition” or “Dial”, for example, to confirm the recognition result. If the result is confirmed by use of the “Dial” key, the stored speech segment is assigned to the address book entry and the number is dialed. If the result is not confirmed by use of the “Cancel” key, the stored speech segment is deleted and a dialing operation is not carried out.

If a stored speech segment is already assigned in association with a recognized address book entry, this is played to the user as well as the screen display. The dialing operation is then started up automatically. The voice acknowledgment (Voice Feedback) provides the user, even in handsfree operation, with the opportunity to check simply whether the recognition result is correct. During the ongoing dialing operation, the user is normally left with enough time to still cancel the dialing operation in the event of an incorrect recognition.

Additionally to the automatic assignment of stored speech segments described above, the user can be offered the opportunity to record and manually assign stored speech segments explicitly himself.

If a plurality of users use a device, user profiles can be created where a user's own speech segments are stored in the respective profile for each user individually. This allows a mixture of voices to be avoided and a homogeneous acoustic sound pattern to be achieved.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV 69 USPQ2d 1865 (Fed. Cir. 2004).

1-11. (canceled)

12. A method for speaker-independent speech recognition, comprising:
inputting a first voice signal;
recognizing the first voice signal and assigning a recognition entry thereto;
storing the first voice signal in a memory as a recorded voice signal assigned to the recognition entry;
inputting a second voice signal;
recognizing the second voice signal and assigning the recognition entry thereto; and
outputting the recorded voice signal stored in the memory as being assigned to the recognition entry.

13. A method according to claim 12, wherein said storing of the first voice signal as assigned to the recognition entry is performed only upon confirmation that the first voice signal has been recognized correctly.

14. A method according to claim 13, further comprising outputting a visual representation of the recognition entry.

15. A method according to claim 14, further comprising:
inputting a third voice signal; and
storing the third voice signal in memory in association with a further recognition entry without intervening speech recognition.

16. A method according to claim 15,
wherein the first, second and third voice signals include proper nouns, and
wherein said method further comprises dialing based on the recognition result when the second voice signal is recognized.

17. A method according to claim 16, performed at a communication facility, wherein said recognizing of the first and second voice signals is speaker independent.

18. A method according to claim 15, wherein the first, second and third voice signals are at least one of town and street names.

19. A method according to claim 18, wherein said recognizing of the first and second voice signals is speaker independent.

20. A method according to claim 15, further comprising controlling applications based on the recognition result.

21. A method according to claim 15, further comprising selecting Internet voice links based on the recognition result.

22. A method according to claim 12, implemented on at least one of embedded hardware and a mobile terminal.

23. A device, comprising:
an input unit inputting first and second voice signals at different times;
a voice recognition unit recognizing the first voice signal and assigning a recognition entry thereto upon receipt of the first voice signal;
a storage unit storing the first voice signal in memory as a recorded voice signal assigned to the recognition entry, said voice recognition unit subsequently recognizing the second voice signal and assigning the recognition entry thereto; and
an output unit outputting the recorded voice signal stored in memory as being assigned to the recognition entry.

24. A device according to claim 23, wherein said device is a mobile terminal further comprising a communication unit.

25. A device according to claim 23, wherein said device is a mobile terminal further comprising a navigation unit.

26. A computer readable medium storing instructions that when executed control a data processing system to perform a method comprising:
inputting a first voice signal;
recognizing the first voice signal and assigning a recognition entry thereto;
storing the first voice signal in memory as a recorded voice signal assigned to the recognition entry;
inputting a second voice signal;
recognizing the second voice signal and assigning the recognition entry thereto; and
outputting the recorded voice signal stored in memory as being assigned to the recognition entry.
